(19) United States
(12) Patent Application Publication
(10) Pub. No.: US 2012/0231341 A1
(43) Pub. Date: Sep. 13, 2012

(54) POSITIVE ACTIVE MATERIAL, AND ELECTRODE AND LITHIUM BATTERY CONTAINING THE POSITIVE ACTIVE MATERIAL

(76) Inventors: Jun-Sik Kim, Yongin-si (KR); Chong-Hoon Lee, Yongin-si (KR); Sung-Soo Kim, Yongin-si (KR); Seo-Jae Lee, Yongin-si (KR); Jeong-Soon Shin, Yongin-si (KR)

(21) Appl. No.: 13/244,392

(22) Filed: Sep. 24, 2011

Related U.S. Application Data
(60) Provisional application No. 61/451,017, filed on Mar. 9, 2011.

(51) Int. Cl. H01M 4/52; B82Y 30/00

(52) U.S. Cl. 429/223; 252/182.1; 977/773

(57) ABSTRACT

Embodiments of the present invention are directed to a positive active material, an electrode including the positive active material, and a lithium battery including the electrode. Due to the inclusion of a phosphate compound having an olivine structure and a lithium nickel composite oxide in the positive active material, the positive active material has high electric conductivity and high electrode density. A lithium battery manufactured using the positive active material has high capacity and good high-rate characteristics.

### CROSS-REFERENCE TO RELATED APPLICATIONS

This application claims priority to and the benefit of U.S. Provisional Application No. 61/451,017, filed on Mar. 9, 2011, in the United States Patent and Trademark Office, the entire content of which is incorporated herein by reference.

### BACKGROUND

1. Field

The present invention relates to positive active materials, electrodes including the positive active materials, and lithium batteries including the electrodes.

2. Description of the Related Art

Recently, lithium secondary batteries have been getting attention as power sources for small and portable electronic devices. Lithium secondary batteries use organic electrolytic solutions, and due to the use of the organic electrolytic solution, lithium secondary batteries have discharge voltages twice that of conventional batteries using alkali aqueous solutions. Thus, lithium secondary batteries have high energy density.

As a positive active material for use in a lithium secondary battery, oxides that intercalate lithium ions and include lithium and a transition metal are often used. Examples of such oxides are LiCoO₂, LiMn₂O₄, and LiNi_{1-x-y}CoₓMn_{y}O₂(0≦x≦0.5, 0≦y≦0.5). It is expected that the demand for middle to large sized lithium secondary batteries will increase in the future. In middle to large sized lithium secondary batteries, stability is an important factor. However, although lithium-containing transition metal oxides have good charge and discharge characteristics and high energy density, they have low thermal stability, and thus, fail to comply with stability requirements in middle to large sized lithium secondary batteries.

Olivine-based positive active materials, such as LiFePO₄, do not generate oxygen even at high temperatures because phosphorous and oxygen are covalently bonded to each other. Accordingly, if an olivine-based positive active material is used in a battery, the battery may have good stability due to the stable crystal structure of the olivine-based positive active material. Thus, research is being conducted into the production of stable, large-sized lithium secondary batteries using olivine-based positive active materials.

However, if electrodes are manufactured with olivine-based positive active materials in the form of nanoparticles to effect efficient intercalation and deintercalation of lithium ions, the electrode has low density. To overcome low electrical conductivity, relatively greater amounts of the conductive agent and binder are used compared to other active materials, making uniform dispersion of the conductive agent during electrode manufacturing difficult, and yielding an electrode with low energy density.

### SUMMARY

One or more embodiments of the present invention include a positive active material capable of improving the electrical conductivity and electrode density of a battery.

One or more embodiments of the present invention include an electrode including the positive active material.

One or more embodiments of the present invention include a lithium battery including the electrode.

According to one or more embodiments of the present invention, a positive active material includes about 70 to about 99 weight (wt) % of a phosphate compound having an olivine structure, and about 1 to about 30 wt % of a lithium nickel composite oxide.

According to one or more embodiments of the present invention, an electrode includes the positive active material.

According to one or more embodiments of the present invention, a lithium battery includes the electrode as a positive electrode, a negative electrode facing the positive electrode, and a separator between the positive electrode and the negative electrode.

A positive active material according to one or more embodiments of the present invention includes a phosphate compound having an olivine structure and a lithium nickel composite oxide. Due to the inclusion of the phosphate compound and the lithium nickel composite oxide, the positive active material has high electrical conductivity and electrode density, thus yielding a lithium battery including the positive active material that has high capacity and good high-rate characteristics.

### BRIEF DESCRIPTION OF THE DRAWINGS

FIG. 1 is a schematic perspective view of a lithium battery according to an embodiment of the present invention.

FIG. 2 is a graph of the charge and discharge results according to rate of the lithium secondary battery manufactured according to Example 14.

FIG. 3 is a graph comparing the discharge capacity retention rate at a 2C-rate versus the amount of NCA in a mixture of LFP and NCA, of the lithium secondary batteries manufactured according to Examples 11 to 15 and Comparative Examples 8 to 11.

FIG. 4 is a graph of the charge and discharge results with respect to the charge cut-off voltage change, of a lithium secondary battery manufactured according to Example 14.

### DETAILED DESCRIPTION

A positive active material according to an embodiment of the present invention includes about 70 to about 99 weight (wt) % of a phosphate compound having' an olivine structure, and about 1 to about 30 wt % of a lithium nickel composite oxide.

The phosphate compound having the olivine structure may be represented by Formula 1 below:

LiMPO₄ Formula 1

In Formula 1, M includes at least one element selected from Fe, Mn, Ni, Co, and V.

The phosphate compound having the olivine structure may be, for example, lithium iron phosphate (LiFePO₄). The phosphate compound having the olivine structure may also include a hetero element, such as Mn, Ni, Co, V, or a combination thereof, as a dopant together with the lithium iron phosphate (LiFePO₄).

The phosphate compound having the olivine structure, such as lithium iron phosphate (LiFePO₄), is structurally stable against volumetric changes caused by charging and discharging due to the tetrahedral structure of PO₄. In particular, phosphorous and oxygen are strongly covalently bonded to each other and have good thermal stability. This will be described further by reference to the electrochemical reaction scheme of LiFePO₄.

LiFePO₄ undergoes intercalation and deintercalation of lithium according to the following reaction scheme.

Intercalation: LiFePO₄−xLi⁺−xe⁻→xFePO₄+(1−x)LiFePO₄

Deintercalation: FePO₄+xLi⁺+xe⁻→xLiFePO₄

Since LiFePO₄ is structurally stable and the structure thereof is similar to that of FePO₄, LiFePO₄ may have very stable cyclic characteristics when charging and discharging are repeatedly performed. Accordingly, the phosphate compound having the olivine structure, such as lithium iron phosphate (LiFePO₄), undergoes a lesser reduction in capacity caused by the collapse of the crystal structure resulting from overcharging and generates less gas. Thus, the high-stability phosphate compound may comply with the stability requirements in, in particular, large-sized lithium ion batteries.

However, in the phosphate compound having the olivine structure, oxygen atoms are hexagonally densely filled and thus lithium ions do not move smoothly, and also, due to its low electrical conductivity, electrons do not move smoothly. However, the positive active material according to embodiments of the present invention includes a lithium nickel composite oxide having a layered-structure and good electrical conductivity in combination with the phosphate compound having the olivine structure. Thus, the positive active material may have higher electrical conductivity than materials using only a phosphate compound having an olivine structure.

Also, during pressing, the lithium nickel composite oxide has a higher active mass density than the phosphate compound having the olivine structure. Thus, the low electrode density characteristics of the phosphate compound having the olivine structure may be overcome, and a battery including the positive active material may have high capacity.

According to an embodiment of the present invention, the lithium nickel composite oxide may be a lithium transition metal oxide containing nickel (Ni), and may be represented by, for example, Formula 2 below.

LiₓNi_{1-y}M′_{y}O_{2-z}X_{z}

In Formula 2, M′ includes at least one metal selected from Co, Al, Mn, Mg, Cr, Fe, Ti, Zr, Mo, and alloys thereof. X is an element selected from O, F, S, and P. Also, 0.9≦x≦1.1, 0≦y≦0.5, and 0≦z≦2.

In order to improve high-temperature durability of the lithium nickel composite oxide, some of the nickel atoms contained in the lithium nickel composite oxide may be doped with at least one metal selected from Co, Al, Mn, Mg, Cr, Fe, Ti, Zr, Mo, and alloys thereof. According to embodiments of the present invention, an NCA (nickel cobalt aluminum) system including Co and Al as M′ (in Formula 2) or an NCM (nickel cobalt manganese) system including Co and Mn as M′ may be used as the lithium nickel composite oxide for improving energy density, structural stability, and electrical conductivity. In some embodiments, for example, the lithium nickel composite oxide may be a nickel-based compound, such as LiNi_{0.8}Co_{0.15}Al_{0.05}O₂ or LiNi_{0.6}Co_{0.2}Mn_{0.2}O₂.

In some exemplary embodiments, the lithium nickel composite oxide may be a lithium nickel cobalt aluminum oxide. For example, the lithium nickel cobalt aluminum oxide may be represented by the following Formula 3:

LiₓNi_{1-y′-y″}Co_{y′}Al_{y″}O₂

In Formula 3, 0.9≦x≦1.1, 0<y′+y″≦0.2, and 0<y″≦0.1.

For example, the NCA system lithium nickel composite oxide may be a nickel-based compound such as LiNi_{0.8}Co_{0.15}Al_{0.05}O₂.

Meanwhile, for example, the NCM system lithium nickel composite oxide may be a nickel-based compound such as LiNi_{0.6}Co_{0.2}Mn_{0.2}O₂.

Regarding the positive active material, if the amount of the lithium nickel composite oxide is too small, the effect of increasing electrical conductivity is negligible. On the other hand, if the amount of the lithium nickel composite oxide is too high, the lithium battery including the positive active material is unstable. Accordingly, the amount of the phosphate compound having the olivine structure may be about 70 to about 99 wt %, and the amount of the lithium nickel composite oxide may be about 1 to about 30 wt %. As described above, by including about 1 to about 30 wt % of the lithium nickel composite oxide in combination with the phosphate compound having the olivine structure as a major component, the battery including the positive active material has good stability and high electrical conductivity. In some embodiments of the present invention, for example, the amount of the phosphate compound having the olivine structure may be about 80 to about 95 wt %, and the amount of the lithium nickel composite oxide may be about 5 to about 20 wt %.

The phosphate compound having the olivine structure may be used in the form of either nano-sized primary particles for highly efficient intercalation and deintercalation of lithium ions, or secondary particles formed by agglomerating two or more primary particles. For example, if the phosphate compound having the olivine structure is used in the form of primary particles, the average particle diameter (D50) may be about 50 to about 2000 nm, for example, about 200 to about 1000 nm. If the phosphate compound having the olivine structure is used in the form of secondary particles formed by agglomerating primary particles, the average particle diameter (D50) may be about 1 to about 30 μm.

A surface of the phosphate compound having the olivine structure may be coated with an amorphous layer formed of carbon or metal oxide. In this case, since the amorphous layer formed of carbon or metal oxide coated on the surface is not crystalline, lithium ions are allowed to be intercalated in or deintercalated from the phosphate compound having the olivine structure (which is a core part) through the amorphous layer (which is a shell part). In addition to allowing the passage of lithium ions, the amorphous layer formed of carbon or metal oxide coated on the surface has good electron conductivity, and thus functions as a pathway for applying electric current to the phosphate compound core, thereby enabling charging and discharging at high rates. Also, if the phosphate compound having the olivine structure is coated with the amorphous layer formed of carbon or metal oxide, the unnecessary reaction between the core material and the electrolytic solution may be controlled, and thus a battery having the positive active material may have good stability.

The lithium nickel composite oxide may be used in the form of either primary particles or secondary particles formed by agglomerating two or more primary particles, and the particle diameter of the lithium nickel composite oxide may be appropriately determined such that the oxide is suitable for assisting electron conductivity of the phosphate compound having the olivine structure. For example, the particle diameter of the lithium nickel composite oxide may be smaller or greater than that of the phosphate compound having the olivine structure. For example, regarding the primary or secondary particles of the lithium nickel composite oxide, the average particle diameter (D50) may be about 0.2 to about 20 μm, for example, about 0.5 to about 7 μm.

An electrode according to an embodiment of the present invention includes the positive active material. The electrode includes the positive active material as described above and may be used as a positive electrode for a lithium battery.

Hereinafter, an exemplary method of manufacturing the electrode will be described in detail. First, a composition for forming a positive active material layer is prepared. The composition includes the positive active material according to an above embodiment of the present invention, a conductive agent, and a binder. The composition is mixed with a solvent to prepare a positive electrode slurry, and then the positive electrode slurry is directly coated and dried on the positive current collector to prepare a positive electrode plate. Alternatively, the positive electrode slurry is coated on a separate support to form a film, and then the film is separated from the separate support and laminated on a positive current collector to prepare the positive electrode plate.

The binder used in the composition for forming the positive active material layer enhances the bonding between the active material and the conductive agent and the bonding between the active material and the current collector. Nonlimiting examples of the binder include polyvinylidenefluoride, vinylidenefluoride/hexafluoropropylene copolymers, polyacrylonitrile, polymethylmethacrylate, polyvinylalcohol, carboxymethylcellulose (CMC), starch, hydroxypropylcellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubbers, fluoro rubbers, and various copolymers. The amount of the binder may be about 1 to about 5 wt % based on the total weight of the composition for forming the positive active material layer. If the amount of the binder is within this range, the positive active material layer may be appropriately attached to the current collector.

The conductive agent used in the composition for forming the positive active material layer may be any one of various materials so long as it is conductive and does not cause a chemical change in the battery. Nonlimiting examples of the conductive agent include graphite, such as natural graphite or artificial graphite; carbon black, such as carbon black, acetylene black, ketjen black, channel black, furnace black, lamp black, or thermal black; conductive fibers, such as carbon fibers, or metal fibers; metal powders, such as fluorinated carbon powders, aluminum powders, or nickel powders; conductive whiskers, such as zinc oxide, or potassium titanate; conductive metal oxides, such as titanium oxide; and conductive materials, such as polyphenylene derivatives. An amount of the conductive agent may be about 1 to about 8 wt % based on the total weight of the composition for forming the positive active material layer. If the amount of the conductive agent is within this range, an electrode manufactured using the conductive agent may have good conductivity.

The solvent used in the composition for forming a positive active material layer to prepare the positive electrode slurry may be N-methylpyrrolidone (NMP), acetone, water, etc. An amount of the solvent may be about 1 to about 10 parts by weight based on 100 parts by weight of the composition for forming the positive active material layer. If the amount of the solvent is within this range, the positive active material layer may be easily formed.

The positive current collector on which the positive electrode slurry is to be coated or laminated may have a thickness of about 3 to about 500 μm, and may be formed of any one of various materials that have high conductivity and that do not cause any chemical change in a battery. For example, the positive current collector may be formed of stainless steel, aluminum, nickel, titanium, calcined carbon or aluminum, or stainless steel that is surface-treated with carbon, nickel, titanium, or silver. The positive current collector may have an uneven surface to enable stronger attachment of the positive active material to the collector, and may be formed of a film, a sheet, a foil, a net, a porous material, a foam, or a nonwoven fabric.

The positive electrode slurry may be directly coated or dried on the positive current collector, or a separate film formed of the positive electrode slurry may be laminated on the positive current collector, and then the resultant structure is pressed to complete manufacturing of a positive electrode.

When the electrode including the positive active material is pressed, its active mass density may change according to the applied pressure. The active mass density of the electrode may be about 2.1 g/cc or more. For example, the active mass density of the electrode may be about 2.1 to about 2.7 g/cc. Meanwhile, in general, an active mass density of a positive electrode formed using only an olivine-based positive active material is about 1.8 to about 2.1 g/cc. Accordingly, by further including the lithium nickel composite oxide, it is confirmed that the active mass density of the positive electrode can be increased. By doing this, a battery using an olivine-based positive active material has high capacity.

A lithium battery according to an embodiment of the present invention includes the electrode as a positive electrode. According to an embodiment of the present invention, the lithium battery includes the electrode described above as a positive electrode; a negative electrode disposed facing the positive electrode; and a separator disposed between the positive electrode and the negative electrode. Exemplary methods of manufacturing positive and negative electrodes and lithium batteries including the positive and negative electrodes will now be described in detail.

A positive electrode and a negative electrode are manufactured by coating and drying a positive electrode slurry and a negative electrode slurry on a positive current collector and negative current collector, respectively. A method of manufacturing the positive electrode may be the same as that discussed above.

In order to manufacture the negative electrode, a negative active material, a binder, a conductive agent, and a solvent are mixed to prepare a negative electrode slurry for forming the negative electrode. The negative active material may be any one of various materials that are conventionally used in the art. Nonlimiting examples of the negative active material include lithium metal, metals capable of alloying with lithium, transition metal oxides, materials capable of doping or dedoping lithium, and materials in which lithium ions are reversibly intercalated or from which lithium ions are reversibly deintercalated.

Nonlimiting examples of transition metal oxides include tungsten oxide, molybdenum oxide, titanium oxide, lithium titanium oxide, vanadium oxide, and lithium vanadium oxide. Nonlimiting examples of materials capable of doping or dedoping lithium include Si, SiOₓ (where0<x<2), Si—Y alloys (where Y is selected from alkali metals, alkaline earth metals, Group 13 elements, Group 14 elements, transition metals, rare earth elements, and combinations thereof, but Y is not Si,) Sn, SnO₂, Sn—Y alloys (where Y is selected from alkali metals, alkaline earth metals, Group 13 elements, Group 14 elements, transition metals, rare earth elements, and combinations thereof, but Y is not Sn), and mixtures of at least one of the foregoing materials with SiO₂. Nonlimiting examples of the element Y include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and combinations thereof.

Nonlimiting examples of materials in which lithium ions are reversibly intercalated or from which lithium ions are reversibly deintercalated include any one of various carbonaceous materials used in conventional lithium batteries. For example, materials in which lithium ions are reversibly intercalated or from which lithium ions may be reversibly deintercalated include crystalline carbon, amorphous carbon, and mixtures thereof. Nonlimiting examples of crystalline carbon materials include amorphous, plate-shaped, flake-shaped, spherical, or fiber-shaped natural graphite; and artificial graphite. Nonlimiting examples of amorphous carbon materials include soft carbon (low-temperature calcined carbon), hard carbon, mesophase pitch carbide, and calcined cokes.

The conductive agent, the binder, and the solvent for use in the negative electrode slurry may be the same as those used in manufacturing the positive electrode. In another embodiment, a plasticizer may be further added to the positive electrode slurry and/or the negative electrode slurry to form pores in the electrode plate. The amounts of the negative active material, the conductive agent, the binder, and the solvent may be the same as those used in conventional lithium batteries.

The negative current collector may have a thickness of about 3 to about 500 μm. A material for forming the negative current collector may be any one of various materials so long as it is conductive and does not cause any chemical change in a battery. Nonlimiting examples of the material for forming the negative current collector include copper, stainless steel, aluminum, nickel, titanium, calcined carbon, copper, and stainless steel surface-treated with carbon, nickel, titanium, silver, and aluminum-cadmium alloys. Like the positive current collector, the negative current collector may have an uneven surface to enable stronger attachment of the negative active material to the collector, and may be formed of a film, a sheet, a foil, a net, a porous material, a foam, or a nonwoven fabric.

Like in manufacturing the positive electrode, the negative electrode slurry is directly coated and dried on the negative current collector to form a negative electrode plate. Alternatively, the negative electrode slurry may be cast on a separate support to for a film which is then separated from the support and laminated on the negative current collector to prepare a negative electrode plate.

The positive electrode and the negative electrode may be spaced from each other by the separator, and the separator may be any one of various separators conventionally used in lithium batteries. In particular, the separator may be a separator that has low resistance to the migration of the ions of the electrolyte and has high electrolyte retention capabilities. Nonlimiting examples of the separator include glass fibers, polyester, Teflon, polyethylene, polypropylene, polytetrafluoroethylene(PTFE), and combinations thereof, each of which may be in a nonwoven or woven form. The separator may have a pore diameter of about 0.01 to about 10 μm, and a thickness of about 5 to about 300 μm.

A lithium salt-containing non-aqueous electrolyte may include a non-aqueous electrolyte and a lithium salt. Nonlimiting examples of the non-aqueous electrolyte include non-aqueous electrolytic solutions, organic solid electrolytes, and inorganic solid electrolytes.

A nonlimiting example of a non-aqueous electrolytic solution is a nonprotonic organic solvent, such as N-methyl-2-pyrrolidone, propylene carbonate, ethylene carbonate, butylene carbonate, dimethyl carbonate, diethyl carbonate, gamma-butyrolactone, 1,2-dimethoxy ethane, tetrahydrofuran, 2-methyl tetrahydrofuran, dimethylsulfoxide, 1,3-dioxolane, formamide, dimethylformamide, acetonitrile, nitromethane, methyl formic acid, methyl acetic acid, phosphoric acid triester, trimethoxy methane, dioxolane derivatives, sulfolanes, methyl sulfolanes, 1,3-dimethyl-2-imidazolidinone, propylene carbonate derivatives, tetrahydrofuran derivatives, ethers, methyl propionic acid, and ethyl propionic acid.

Nonlimiting examples of an organic solid electrolyte include polyethylene derivatives, polyethylene oxide derivatives, polypropylene oxide derivatives, ester phosphate polymers, polyester sulfides, polyvinyl alcohol, poly vinylidene fluoride, and polymers containing an ionic dissociating group.

Nonlimiting examples of an inorganic solid electrolyte include nitrides, halides, or sulfides of Li, such as Li₃N, LiI, Li₅NI₂, Li₃N—LiI—LiOH, Li₂SiS₃, Li₄SiO₄, Li₄SiO₄—LiI—LiOH, and Li₃PO₄—Li₂S—SiS₂.

The lithium salt may be any one of various materials used in conventional lithium batteries and that are easily dissolved in a non-aqueous electrolyte. Nonlimiting examples of the lithium salt include LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, LiN(CF₃SO₂)₂, lithium chloro borate, lower aliphatic lithium carbonic acids, lithium 4-phenyl boric acid, and combinations thereof.

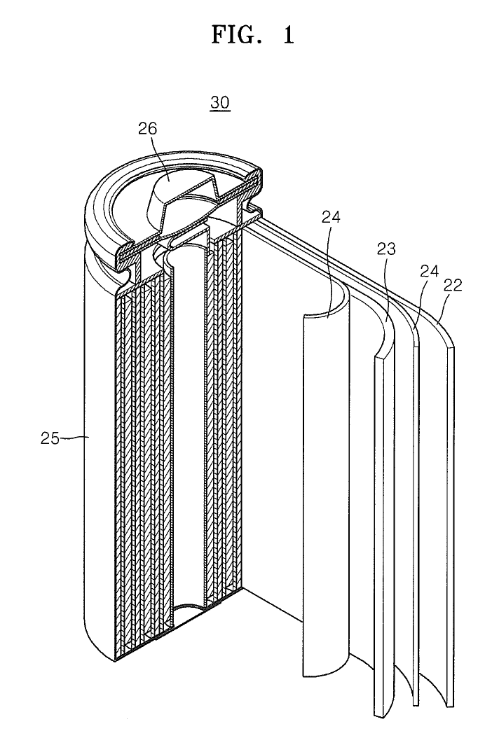

FIG. 1 is a schematic perspective view of a lithium battery 30 according to an embodiment of the present invention. Referring to FIG. 1, the lithium battery 30 includes a positive electrode 23, a negative electrode 22, and a separator 24 between the positive electrode 23 and the negative electrode 22. The positive electrode 23, the negative electrode 22, and the separator 24 are wound or folded and placed in a battery case 25. Then, an electrolyte is injected into the battery case 25 and the resultant structure is sealed by a sealing member 26, thereby completing the manufacture of the lithium battery 30. The battery case 25 may be cylindrical, rectangular, or a thin-film shape. The lithium battery 30 may be a lithium ion battery.

The lithium battery 30 may be used in conventional mobile phones and conventional portable computers. Also, the lithium battery 30 may be used in applications requiring high capacity, high output, and high-temperature operation, such as electric vehicle applications. In addition, the lithium battery 30 may be combined with conventional internal-combustion engines, fuel cells, or super capacitors to be used in hybrid vehicles. Furthermore, the lithium battery 30 may be used in various other applications requiring high output, high voltage, and high-temperature operation.

The following Examples are presented for illustrative purposes only, and they do not limit the scope of the present invention.

### Preparation Example 1

### Synthesis of LiFePO₄

LiFePO₄ was prepared by solid-phase synthesis. FeC₂O₄.2H₂O, NH₄H₂PO₄, and Li₂CO₃ were mixed in a stoichiometric ratio corresponding to LiFePO₄ and milled to prepare an active material. Then, sucrose was added to the active material in an amount of 5% of the active material, and calcination was performed thereon at a temperature of 700° C. while N₂ was provided at an inert atmosphere for 8 hours, thereby synthesizing LiFePO₄.

### Preparation Example 2

### Synthesis of LiNi_{0.8}Co_{0.15}Al_{0.05}O₂

In order to prepare LiNi_{0.8}Co_{0.15}Al_{0.05}O₂ as an NCA positive active material, nitrate hydrates of Ni, Co, and Al (i.e., Ni(NO₃)₂.6H₂O, Co(NO₃)₂.6H₂O and Al(NO₃)₃.9H₂O, respectively) were mixed at a mixture ratio corresponding to the stoichiometric ratio (Ni:Co:Al=0.8:0.15:0.05) to prepare a homogeneous solution. Ammonia water was added thereto to adjust the pH of the solution to 9 and then coprecipitation was performed thereon. Then, the precipitate was washed and dried at a temperature of 150° C. for 6 hours. Then, Li₂CO₃ was mixed with the resulting product in an amount corresponding to the mole ratio described above, and then the mixture was milled and sintered at a temperature of 750° C. for 12 hours, thereby completing synthesis of LiNi_{0.8}Co_{0.15}Al_{0.05}O₂.

### Preparation Example 3

### Synthesis of LiNi_{0.6}Co_{0.2}Mn_{0.2}O₂

In order to prepare LiNi_{0.6}Co_{0.2}Mn_{0.2}O₂ as an NCM positive active material, nitrate hydrates of Ni, Co, and Mn (i.e., Ni(NO₃)₂.6H₂0, Co(NO₃)₂.6H₂0 and Mn(NO₃)₂.6H₂O, respectively) were mixed in a mixture ratio corresponding to the stoichiometric ratio (Ni:Co:Mn=0.6:0.2:0.2) to prepare a homogeneous solution. Ammonia water was added thereto to adjust the pH of the solution to 10 and then coprecipitation was performed thereon. Then, the precipitate was washed and dried at a temperature of 150° C. for 6 hours. Then, Li₂CO₃ was mixed with the resulting product in an amount corresponding to the mole ratio described above, and then the mixture was milled and sintered at a temperature of 870° C. for 20 hours, thereby completing synthesis of LiNi_{0.6}Co_{0.2}Mn_{0.2}O₂.

Particle distributions of the positive active materials prepared according to Preparation Examples 1 to 3 were measured, and the results are shown in Table 1 below.

TABLE 1

| Positive active | | | | |
|---|---|---|---|---|
| material | Particle Composition | D50 | D10 | D90 |
| Preparation | LiFePO₄ | 1.54 | 0.45 | 6.45 |
| Example 1 | | | | |
| Preparation | LiNi_{0.8}Co_{0.15}Al_{0.05}O₂ | 3.04 | 1.07 | 7.78 |
| Example 2 | | | | |
| Preparation | LiNi_{0.6}Co_{0.2}Mn_{0.2}O₂ | 3.23 | 1.15 | 8.65 |
| Example 3 | | | | |

### Evaluation Examples 1 and 2

### Evaluation of Pellet Density According to Mixture Ratio of Positive Active Materials (Evaluation Example 1) and Evaluation of Electrical Conductivity According to Mixture Ratio of Positive Active Materials (Evaluation Example 2)

### Examples 1 to 5 and Comparative Examples 1 to 6

### Mixture of LFP (LiFePO₄) and NCA (LiNi_{0.8}Co_{0.15}Al_{0.05}O₂)

LiFePO₄ (hereinafter referred to as ‘LFP’) powder as the positive active material prepared according to Preparation Example 1, and LiNi_{0.8}Co_{0.15}Al_{0.05}O₂ (hereinafter referred to as ‘NCA’) powder as the positive active material prepared according to Preparation Example 2 were mixed at a specified ratio and pressed to prepare pellets.

Regarding the pellets of Examples 1 to 5 and Comparative Examples 1 to 6, pellet density and electrical conductivity according to the mixture ratio of the positive active materials and the applied pressure were measured, and the results are shown in Tables 2 and 3 below. Tables 2 and 3 also show the types and mixture ratios of the positive active materials used in each of the Examples and the Comparative Examples.

TABLE 2

| | Positive active | | | | | | | |
|---|---|---|---|---|---|---|---|---|
| | material | | Applied | | | | | |
| | composition, wt % | | pressure | | | | | |
| | LFP | NCA | (kN) | 4 | 8 | 12 | 16 | 20 |
| Comparative | 100 | — | Pellet | 2.03 | 2.18 | 2.28 | 2.38 | 2.46 |
| Example 1 | | | density | | | | | |
| | | | (g/cc) | | | | | |
| Example 1 | 99 | 1 | Pellet | 2.04 | 2.19 | 2.30 | 2.42 | 2.48 |
| | | | density | | | | | |
| | | | (g/cc) | | | | | |
| Example 2 | 95 | 5 | Pellet | 2.17 | 2.30 | 2.41 | 2.48 | 2.57 |
| | | | density | | | | | |
| | | | (g/cc) | | | | | |
| Example 3 | 90 | 10 | Pellet | 2.23 | 2.37 | 2.47 | 2.56 | 2.64 |
| | | | density | | | | | |
| | | | (g/cc) | | | | | |
| Example 4 | 80 | 20 | Pellet | 2.25 | 2.42 | 2.54 | 2.64 | 2.75 |
| | | | density | | | | | |
| | | | (g/cc) | | | | | |
| Example 5 | 70 | 30 | Pellet | 2.31 | 2.47 | 2.60 | 2.72 | 2.82 |
| | | | density | | | | | |
| | | | (g/cc) | | | | | |
| Comparative | 60 | 40 | Pellet | 2.33 | 2.52 | 2.68 | 2.83 | 2.94 |
| Example 2 | | | density | | | | | |
| | | | (g/cc) | | | | | |
| Comparative | 50 | 50 | Pellet | 2.54 | 2.69 | 2.78 | 2.88 | 2.95 |
| Example 3 | | | density | | | | | |
| | | | (g/cc) | | | | | |
| Comparative | 20 | 80 | Pellet | 2.83 | 2.97 | 3.05 | 3.14 | 3.37 |
| Example 4 | | | density | | | | | |
| | | | (g/cc) | | | | | |
| Comparative | 10 | 90 | Pellet | 2.92 | 3.05 | 3.15 | 3.28 | 3.44 |
| Example 5 | | | density | | | | | |
| | | | (g/cc) | | | | | |
| Comparative | — | 100 | Pellet | 3.01 | 3.16 | 3.29 | 3.40 | 3.52 |
| Example 6 | | | density | | | | | |
| | | | (g/cc) | | | | | |

TABLE 3

| | Positive active | | | | | | | |
|---|---|---|---|---|---|---|---|---|
| | material | | Applied | | | | | |
| | composition, wt % | | pressure | | | | | |
| | LFP | NCA | (kN) | 4 | 8 | 12 | 16 | 20 |
| Comparative | 100 | — | Electrical | 3.4E−03 | 4.3E−03 | 5.0E−03 | 5.6E−03 | 6.1E−03 |
| Example 1 | | | conductivity | | | | | |
| | | | (S/cm) | | | | | |
| Example 1 | 99 | 1 | Electrical | 3.5E−03 | 4.4E−03 | 5.1E−03 | 5.7E−03 | 6.2E−03 |
| | | | conductivity | | | | | |
| | | | (S/cm) | | | | | |
| Example 2 | 95 | 5 | Electrical | 3.6E−03 | 4.6E−03 | 5.4E−03 | 6.1E−03 | 6.7E−03 |
| | | | conductivity | | | | | |
| | | | (S/cm) | | | | | |
| Example 3 | 90 | 10 | Electrical | 3.8E−03 | 4.9E−03 | 5.7E−03 | 6.4E−03 | 7.0E−03 |
| | | | conductivity | | | | | |
| | | | (S/cm) | | | | | |
| Example 4 | 80 | 20 | Electrical | 3.5E−03 | 4.6E−03 | 5.5E−03 | 6.3E−03 | 7.1E−03 |
| | | | conductivity | | | | | |
| | | | (S/cm) | | | | | |
| Example 5 | 70 | 30 | Electrical | 3.5E−03 | 4.5E−03 | 5.5E−03 | 6.4E−03 | 7.2E−03 |
| | | | conductivity | | | | | |
| | | | (S/cm) | | | | | |
| Comparative | 60 | 40 | Electrical | 2.2E−03 | 3.2E−03 | 4.1E−03 | 4.9E−03 | 5.7E−03 |
| Example 2 | | | conductivity | | | | | |
| | | | (S/cm) | | | | | |
| Comparative | 50 | 50 | Electrical | 2.9E−03 | 4.1E−03 | 4.9E−03 | 5.8E−03 | 6.5E−03 |
| Example 3 | | | conductivity | | | | | |
| | | | (S/cm) | | | | | |
| Comparative | 20 | 80 | Electrical | 3.2E−03 | 5.6E−03 | 7.8E−03 | 1.0E−02 | 1.1E−02 |
| Example 4 | | | conductivity | | | | | |
| | | | (S/cm) | | | | | |
| Comparative | 10 | 90 | Electrical | 4.1E−03 | 7.4E−03 | 9.5E−03 | 1.2E−02 | 1.4E−02 |
| Example 5 | | | conductivity | | | | | |
| | | | (S/cm) | | | | | |
| Comparative | — | 100 | Electrical | 6.5E−03 | 9.8E−03 | 1.2E−02 | 1.5E−02 | 1.7E−02 |
| Example 6 | | | conductivity | | | | | |
| | | | (S/cm) | | | | | |

### Examples 6 to 10 and Comparative Examples 7 to 11

### Mixture of LFP (LiFePO₄) and NCM (LiNi_{0.6}Co_{0.2}Mn_{0.2}O₂)

LiFePO₄ (LFP) powder as the positive active material prepared according to Preparation Example 1 and LiNi_{0.6}Co_{0.2}Mn_{0.2}O₂ (hereinafter referred to as ‘NCM’) powder as the positive active material prepared according to Preparation Example 3 were mixed at a specified ratio and pressed to prepare pellets.

Regarding the pellets of Examples 6 to 10 and Comparative Examples 7 to 11, pellet density and electrical conductivity according to the mixture ratio of the positive active materials and the applied pressure were measured, and the results are shown in Tables 4 and 5 below. Tables 4 and 5 also show the types and mixture ratios of the positive active materials used in each of the Examples and the Comparative Examples.

TABLE 4

| | Positive active | | | | | | | |
|---|---|---|---|---|---|---|---|---|
| | material | | Applied | | | | | |
| | composition, wt % | | pressure | | | | | |
| | LFP | NCM | (kN) | 4 | 8 | 12 | 16 | 20 |
| Comparative | 100 | to | Pellet | 2.03 | 2.18 | 2.28 | 2.38 | 2.46 |
| Example 7 | | | density | | | | | |
| | | | (g/cc) | | | | | |
| Example 6 | 99 | 1 | Pellet | 2.04 | 2.21 | 2.34 | 2.44 | 2.54 |
| | | | density | | | | | |
| | | | (g/cc) | | | | | |
| Example 7 | 95 | 5 | Pellet | 2.07 | 2.28 | 2.38 | 2.50 | 2.60 |
| | | | density | | | | | |
| | | | (g/cc) | | | | | |
| Example 8 | 90 | 10 | Pellet | 2.14 | 2.29 | 2.41 | 2.52 | 2.61 |
| | | | density | | | | | |
| | | | (g/cc) | | | | | |
| Example 9 | 80 | 20 | Pellet | 2.27 | 2.46 | 2.61 | 2.72 | 2.83 |
| | | | density | | | | | |
| | | | (g/cc) | | | | | |
| Example 10 | 70 | 30 | Pellet | 2.50 | 2.74 | 2.89 | 3.01 | 3.12 |
| | | | density | | | | | |
| | | | (g/cc) | | | | | |
| Comparative | 50 | 50 | Pellet | 2.54 | 2.73 | 2.91 | 3.05 | 3.20 |
| Example 8 | | | density | | | | | |
| | | | (g/cc) | | | | | |
| Comparative | 20 | 80 | Pellet | 2.82 | 2.93 | 3.10 | 3.29 | 3.41 |
| Example 9 | | | density | | | | | |
| | | | (g/cc) | | | | | |
| Comparative | 10 | 90 | Pellet | 2.90 | 3.01 | 3.19 | 3.41 | 3.49 |
| Example 10 | | | density | | | | | |
| | | | (g/cc) | | | | | |
| Comparative | to | 100 | Pellet | 2.98 | 3.15 | 3.35 | 3.49 | 3.70 |
| Example 11 | | | density | | | | | |
| | | | (g/cc) | | | | | |

TABLE 5

| | Positive active | | | | | | | |
|---|---|---|---|---|---|---|---|---|
| | material | | Applied | | | | | |
| | composition, wt % | | pressure | | | | | |
| | LFP | NCM | (kN) | 4 | 8 | 12 | 16 | 20 |
| Comparative | 100 | to | Electrical | 3.4E−03 | 4.3E−03 | 5.0E−03 | 5.6E−03 | 6.1E−03 |
| Example 7 | | | conductivity | | | | | |
| | | | (S/cm) | | | | | |
| Example 6 | 99 | 1 | Electrical | 4.7E−03 | 6.5E−03 | 7.3E−03 | 7.8E−03 | 9.0E−03 |
| | | | conductivity | | | | | |
| | | | (S/cm) | | | | | |
| Example 7 | 95 | 5 | Electrical | 4.8E−03 | 6.5E−03 | 7.3E−03 | 8.3E−03 | 9.1E−03 |
| | | | conductivity | | | | | |
| | | | (S/cm) | | | | | |
| Example 8 | 90 | 10 | Electrical | 4.7E−03 | 6.5E−03 | 7.4E−03 | 8.4E−03 | 9.0E−03 |
| | | | conductivity | | | | | |
| | | | (S/cm) | | | | | |
| Example 9 | 80 | 20 | Electrical | 4.8E−03 | 6.2E−03 | 7.2E−03 | 8.1E−03 | 8.8E−03 |
| | | | conductivity | | | | | |
| | | | (S/cm) | | | | | |
| Example 10 | 70 | 30 | Electrical | 4.3E−03 | 5.7E−03 | 6.5E−03 | 7.2E−03 | 7.9E−03 |
| | | | conductivity | | | | | |
| | | | (S/cm) | | | | | |
| Comparative | 50 | 50 | Electrical | 3.4E−03 | 4.6E−03 | 5.3E−03 | 6.1E−03 | 6.7E−03 |
| Example 8 | | | conductivity | | | | | |
| | | | (S/cm) | | | | | |
| Comparative | 20 | 80 | Electrical | 3.1E−03 | 4.2E−03 | 5.0E−03 | 5.9E−03 | 6.6E−03 |
| Example 9 | | | conductivity | | | | | |
| | | | (S/cm) | | | | | |
| Comparative | 10 | 90 | Electrical | 3.0E−03 | 4.2E−03 | 4.9E−03 | 5.8E−03 | 6.6E−03 |
| Example 10 | | | conductivity | | | | | |
| | | | (S/cm) | | | | | |
| Comparative | to | 100 | Electrical | 2.9E−03 | 4.1E−03 | 4.9E−03 | 5.8E−03 | 6.5E−03 |
| Example 11 | | | conductivity | | | | | |
| | | | (S/cm) | | | | | |

As shown in Tables 2 to 5, the pellet density when LFP was combined with a nickel-based positive active material, such as NCA or NCM, was higher than that when only LFP was used as the positive active material (Comparative Example 1). Also, the higher the mixture ratio of the nickel-based positive active material to the LFP, and the higher the applied pressure, the higher the pellet density.

Regarding electrical conductivity, when LFP was combined with NCA as the nickel-based positive active material, since NCA had higher electrical conductivity than LFP, in most cases, the greater the amount of the NCA, the higher the electrical conductivity. In particular, when small amounts of the NCA were used (for example, 1 wt %, 5 wt %, 10 wt %), electrical conductivity increased linearly up to the amount of 30 wt %, and the conductivity was maintained at a relatively high level. On the other hand, when the amount of the NCA was 40 wt % and 50 wt %, electrical conductivity was relatively decreased. However, if the amount of the NCA was further increased (for example, 80 wt % and 90 wt %), electrical conductivity increased. The decrease in electrical conductivity at the amounts of 40 wt % and 50 wt % may be due to non-uniform mixing of the two active materials. However, when the amount of the NCA was 40 wt % or more, even though the electrical conductivity increased, thermal stability decreased as shown in the penetration test results shown in Evaluation Example 4 below.

Also, when the amount of the NCM as the nickel-based positive active material was about 1 to about 30 wt %, electrical conductivity was higher than when the amount of the NCM was greater than 30 wt %. Although the electrical conductivity of NCM was lower than the electrical conductivity of NCA and higher than the electrical conductivity of LFP, when pressure was applied and thus pellet density increased, the mixture of LFP and NCM as the active materials resulted in higher electrical conductivity than when LFP and NCM were used separately.

### Examples 11 to 15 and Comparative Examples 12 to 17

### Preparation of Positive Electrodes and Manufacture of Lithium Batteries Using the Positive Electrodes

LFP(LiFePO₄) and NCA(LiNi_{0.8}Co_{0.15}Al_{0.05}O₂) prepared according to Preparation Examples 1 and 2 were used as the positive active material and mixed in the mixture ratios of Examples 1 to 5 and Comparative Examples 1 to 6. Each of the positive active materials, polyvinylidenefluoride (PVdF) as a binder, and carbon as a conductive agent were mixed at a weight ratio of 96:2:2, and then the mixture was dispersed in N-methylpyrrolidone to prepare a positive electrode slurry. The positive electrode slurry was coated to a thickness of 60 μm on an aluminum foil to form a thin electrode plate, and then the thin electrode plate was dried at a temperature of 135° C. for 3 hours or more and pressed, thereby completing manufacture of a positive electrode.

Separately, artificial graphite as a negative active material, and polyvinylidene fluoride as a binder were mixed in a weight ratio of 96:4, and the mixture was dispersed in an N-methylpyrrolidone solvent to prepare a negative electrode slurry. The negative electrode slurry was coated to a thickness of 14 μm on a copper (Cu) foil to form a thin electrode plate, and then the thin electrode plate was dried at a temperature of 135° C. for 3 or more hours and pressed, thereby completing manufacture of a negative electrode.

An electrolytic solution was prepared by adding 1.3M LiPF₆ to a mixed solvent including ethylenecarbonate(EC), ethylmethyl carbonate(EMC), and dimethylcarbonate(DMC) at a volumetric ratio of 1:1:1.

A porous polyethylene (PE) film as a separator was positioned between the positive electrode and the negative electrode to form a battery assembly, and the battery assembly was wound and pressed, and placed in a battery case. Then, the electrolytic solution was injected into the battery case, thereby completing a lithium secondary battery having a capacity of 2600 mAh.

### Evaluation Example 3

### Charge and Discharge Test

Coin cells were manufactured using the positive electrode plates from the lithium batteries manufactured according to Examples 11 to 20 and Comparative Examples 12 to 17, and using lithium metal as a counter electrode, and the same electrolyte. Charge and discharge tests were performed on each of the coin cells by charging each coin cell with a current of 15 mA per 1 g of positive active material until the voltage reached 4.0 V (vs. Li), and then discharging with the same magnitude of current until the voltage reached 2.0 V (vs. Li). Then, charging and discharging were repeatedly performed 50 times within the same current and voltage ranges. Initial coulombic efficiency is represented by Equation 1 below, lifetime capacity retention rate is represented by Equation 2 below, and rate capacity retention rate is represented by Equation 3 below.

Initial coulombic efficiency [%]=[discharge capacity in a 1^{st} cycle/charge capacity in a 1^{st} cycle]×100 Equation 1

Lifetime capacity retention rate [%]=discharge capacity in a 100th cycle/discharge capacity in a 2^{nd} cycle Equation 2

Rate capacity retention rate [%]=discharge capacity at a corresponding C-rate/discharge capacity in an initial 0.1C−rate Equation 3

The initial coulombic efficiency and lifetime capacity retention rate of Examples 11 to 15 and Comparative Examples 12 to 17 are shown in Table 6 below.

TABLE 6

| | | | | Lifetime |
|---|---|---|---|---|
| | Positive active material | | Initial | capacity reten- |
| | composition, wt % | | coulombic | tion rate (%) |
| | LFP | NCA | efficiency (%) | @ 100 cycle |
| Comparative | 100 | to | 91.5 | 82.7 |
| Example 12 | | | | |
| Example 11 | 99 | 1 | 91.9 | 82.8 |
| Example 12 | 95 | 5 | 92.0 | 84.2 |
| Example 13 | 90 | 10 | 91.6 | 84.8 |
| Example 14 | 80 | 20 | 92.1 | 85.4 |
| Example 15 | 70 | 30 | 93.1 | 84.5 |
| Comparative | 60 | 40 | 92.9 | 80.8 |
| Example 13 | | | | |
| Comparative | 50 | 50 | 92.7 | 78.8 |
| Example 14 | | | | |
| Comparative | 20 | 80 | 92.7 | 74.5 |
| Example 15 | | | | |
| Comparative | 10 | 90 | 92.8 | 73.4 |
| Example 16 | | | | |
| Comparative | to | 100 | 92.8 | 72.8 |
| Example 17 | | | | |

As shown in Table 6, the lithium secondary batteries manufactured according to Examples 11 to 15 have higher initial coulombic efficiency and lifetime capacity retention rate than the lithium secondary batteries manufactured according to Comparative Examples 12 to 17. That is, the greater the amount of NCA (LiNi_{0.8}Co_{0.15}Al_{0.05}O₂) in the positive active material, the higher the initial coulombic efficiency. However, when the amount of NCA is greater than 30 wt %, the increase in the initial coulombic efficiency was saturated and thus, the initial coulombic efficiency did not increase any more. Regarding the lifetime capacity retention rate, when 40 wt % or more of NCA was included, the lifetime capacity retention rate was rapidly reduced. That is, although the initial coulombic efficiency was increased due to improvements in the conductivity of LFP (LiFePO₄) caused by mixing with NCA, when the amount of NCA was 40 wt % or more, the lifetime characteristics of the LFP were reduced. In consideration of these results, it was confirmed that an appropriate amount of NCA was equal to or lower than 30 wt %.

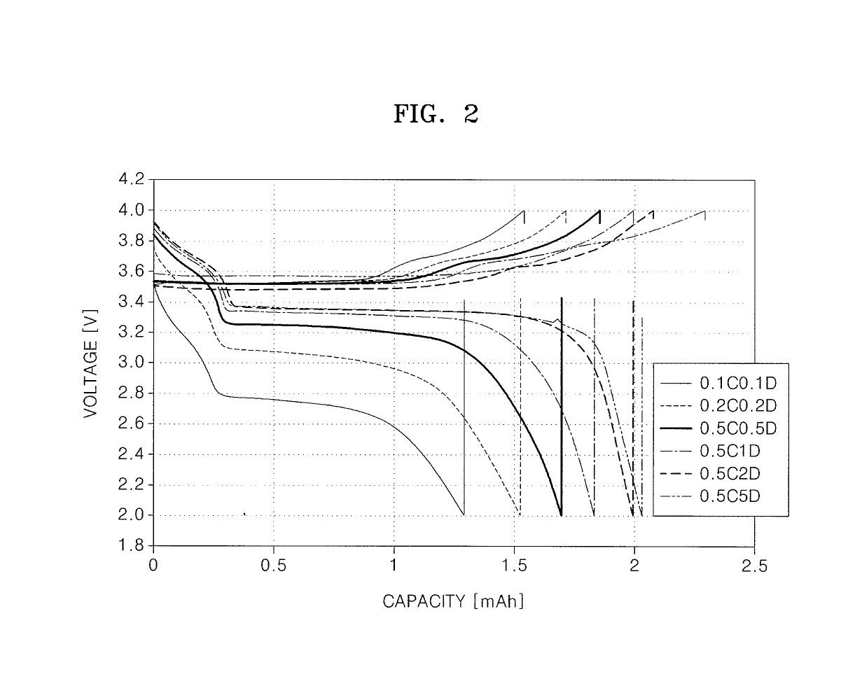

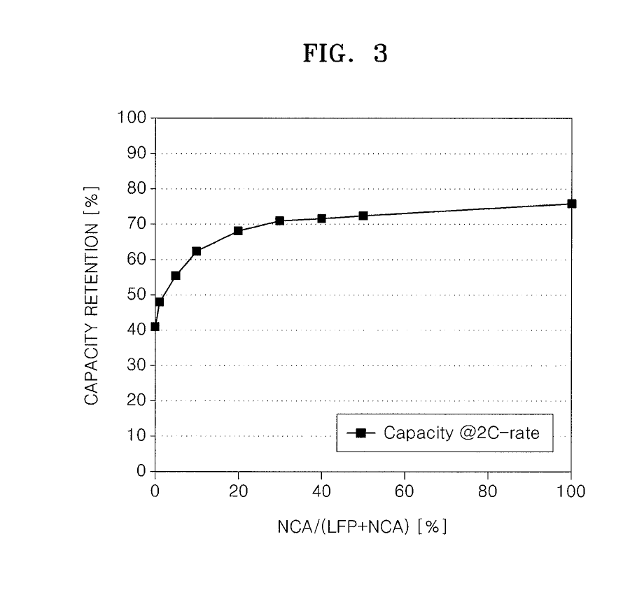

Rate charge discharge results of the lithium secondary battery of Example 14 manufactured using the LFP positive active material including 20 wt % NCA are shown in FIG. 2. Also, the discharge capacity retention rate [%] at a 2 C-rate was measured according to a mixture ratio of LFP to NCA, and the results are shown in FIG. 3.

Referring to FIG. 2, the higher the discharge rate, the smaller the discharge capacity. Such results may be due to the increasing resistance. However, when the mixture ratio of NCA was increased, as shown in FIG. 3, the discharge capacity retention rate [%] increased until the amount of NCA reached about 30 wt %. Such results may be due to an increase in conductivity due to mixture with NCA, and it was confirmed that the capacity increase is saturated when the amount of NCA is about 30 wt %.

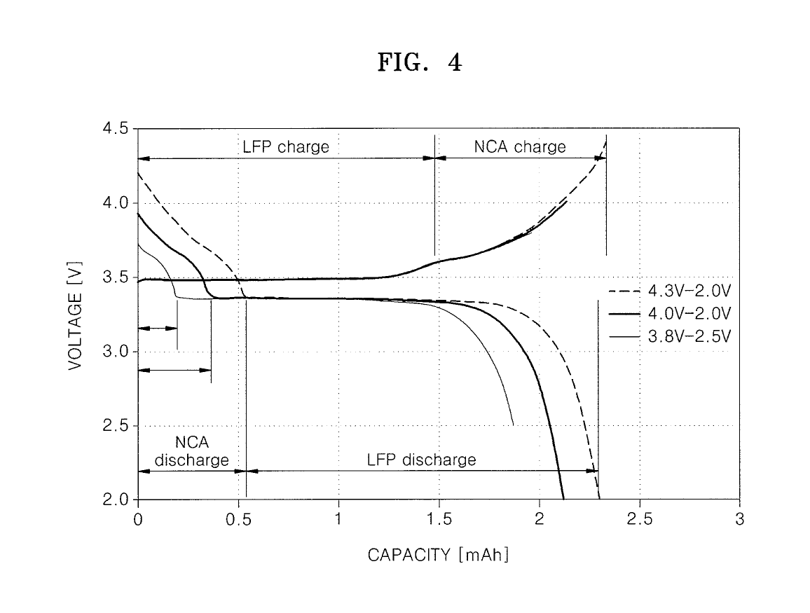

Regarding a LFP/NCA mixed positive electrode, in order to confirm the capacity ratio of respective active materials, charge and discharge tests were performed on the lithium secondary battery of Example 14 manufactured using the LFP positive active material including 20 wt % NCA under various charge and discharge conditions, and the results are shown in FIG. 4. The capacity ratio of the respective positive active materials was roughly determined and represented by arrows. As shown in FIG. 4, the higher the charge cut-off voltage, the greater the capacity. Such a result may be due to the fact that the higher charge and discharge potential of NCA compared to LFP results in higher charge voltage, thereby inducing the expression of capacity of NCA. If the charge cut-off voltage is controlled to sufficiently express the capacity of NCA in the LFP/NCA mixed positive electrode, the capacity of NCA may be sufficiently used up to 40% or more or 70% or more.

### Evaluation Example 4

### Penetration Test

Penetration tests were performed on each of the lithium secondary batteries manufactured using the positive electrodes prepared according to Examples 11 to 15, and Comparative Examples 12, 13, 15, 16, and 17, and the results are shown in Table 7 below.

The penetration test was performed as follows: the lithium secondary batteries manufactured using the positive electrodes prepared according to Examples 11 to 15, and Comparative Examples 12, 13, 15, 16, and 17 were charged with a current of 0.5 C until the voltage reached 4.2 V for 3 hours, and then left for about 10 minutes (possibly up to 72 hours). Then, the center of the lithium secondary battery was completely penetrated by a pin having a diameter of 5 mm moving at a speed of 60 mm/sec.

In Table 4, LX (where X is about 0 to about 5) indicates the stability of the battery, and if the X value is smaller, battery stability is increased. That is, LX has the following meanings:
L0: no change, L1: leakage, L2: fumed, L3: combustion while dissipating at 200° C. or lower heat, L4: combustion while dissipating at 200° C. or greater heat, L5: explosion

TABLE 7

| | Positive active material | | |
|---|---|---|---|
| | composition, wt. % | | Penetration |
| | LFP | NCA | test |
| Comparative | 100 | to | L0 |
| Example 12 | | | |
| Example 11 | 99 | 1 | L0 |
| Example 12 | 95 | 5 | L0 |
| Example 13 | 90 | 10 | L0 |
| Example 14 | 80 | 20 | L0 |
| Example 15 | 70 | 30 | L1 |
| Comparative | 60 | 40 | L4 |
| Example 13 | | | |
| Comparative | 20 | 80 | L4 |
| Example 15 | | | |
| Comparative | 10 | 90 | L4 |
| Example 16 | | | |
| Comparative | to | 100 | L4 |
| Example 17 | | | |

As shown in Table 7, at up to 30 wt % of NCA(LiNi_{0.8}Co_{0.15}Al_{0.05}O₂), combustion did not occur in the penetration test. Thus, it was confirmed that the lithium secondary battery had high thermal stability. However, when the amount of NCA was 40 wt % or more, combustion occurred in the penetration test. Thus, it was confirmed that the lithium secondary battery had low thermal stability. Accordingly, it can be seen that the lithium secondary batteries of the Examples have higher thermal stability than those of the Comparative Examples.

While certain exemplary embodiments have been described and illustrated, those of ordinary skill in the art will understand that certain modifications and changes can be made to the described embodiments without departing from the spirit and scope of the invention as described in the appended claims. Also, descriptions of features or aspects within each embodiment should typically be considered as available for other similar features or aspects in other embodiments.

What is claimed is:

1. A positive active material for a lithium rechargeable battery, comprising:
about 70 wt % to about 99 wt % of a phosphate compound having an olivine structure; and
about 1 wt % to about 30 wt % of a lithium nickel composite oxide.

2. The positive active material of claim 1, wherein the phosphate compound having the olivine structure comprises a compound represented by Formula 1:
LiMPO₄
wherein M is selected from the group consisting of Fe, Mn, Ni, Co, V and combinations thereof.

3. The positive active material of claim 2, wherein the phosphate compound comprises LiFePO₄.

4. The positive active material of claim 2, wherein M comprises a combination of Fe and at least one heteroelement.

5. The positive active material of claim 4, wherein the heteroelement is selected from the group consisting of Mn, Ni, Co, V, and combinations thereof.

6. The positive active material of claim 1, wherein the lithium nickel composite oxide comprises a nickel-containing lithium transition metal oxide represented by Formula 2:
LiₓNi_{1-y}M′_{y}O_{2-z}X_{z} Formula 2
wherein:
M′ is at least one metal selected from the group consisting of Co, Al, Mn, Mg, Cr, Fe, Ti, Zr, Mo, and alloys thereof;
X is an element selected from the group consisting of O, F, S, P and combinations thereof;
0.9≦x≦1.1;
0≦y≦0.5; and
0≦z≦2.

7. The positive active material of claim 6, wherein 0≦y≦0.2.

8. The positive active material of claim 6, wherein the lithium nickel composite oxide comprises a compound represented by Formula 3:
LiₓNi_{1-y′-y″}Co_{y′}Al_{y″}O₂ Formula 3:
wherein:
0.9≦x≦1.1;
0<y′+y″≦0.2; and
0<y″≦0.1.

9. The positive active material of claim 6, wherein the lithium nickel composite oxide is selected from the group consisting of LiNi_{0.8}Co_{0.15}Al_{0.05}O₂, LiNi_{0.6}Co_{0.2}Mn_{0.2}O₂, and combinations thereof.

10. The positive active material of claim 1, wherein the phosphate compound having the olivine structure comprises primary particles having an average particle diameter of about 50 to about 2000 nm.

11. The positive active material of claim 1, wherein the phosphate compound having the olivine structure comprises secondary particles which comprise agglomerations of primary particles, wherein the secondary particles have an average agglomerated particle diameter (D50) of about 1 to about 30 μm.

12. The positive active material of claim 1, further comprising an amorphous coating layer on a surface of the phosphate compound having the olivine structure.

13. The positive active material of claim 12, wherein the amorphous layer comprises a carbon material, or a metal oxide material.

14. The positive active material of claim 1, wherein the lithium nickel composite oxide comprises particles having an average particle size (D50) of about 0.2 to about 20 μm.

15. A positive electrode for a rechargeable lithium battery, comprising a positive active material comprising:
about 70 wt % to about 99 wt % of a phosphate compound having an olivine structure; and
about 1 wt % to about 30 wt % of a lithium nickel composite oxide.

16. The positive electrode of claim 15, wherein the positive active material further comprises an amorphous coating layer on a surface of the phosphate compound having the olivine structure.

17. The positive electrode of claim 15, wherein an active mass density of the electrode is about 2.1 g/cc or greater.

18. A lithium rechargeable battery, comprising:
a positive electrode comprising a positive active material comprising:
about 70 wt % to about 99 wt % of a phosphate compound having an olivine structure; and
about 1 wt % to about 30 wt % of a lithium nickel composite oxide;
a negative electrode comprising a negative active material; and
an electrolyte.

19. The lithium rechargeable battery of claim 18, wherein the positive active material further comprises an amorphous coating layer on a surface of the phosphate compound having the olivine structure.

20. The lithium rechargeable battery of claim 18, wherein the positive electrode has an active mass density of about 2.1 g/cc or greater.
